(19) United States
(12) Patent Application Publication
(10) Pub. No.: US 2026/0339850 A1
(43) Pub. Date: Oct. 29, 2026

(54) SYSTEM AND METHOD FOR CONTROLLING FILE-WRITING DISPATCH IN A MULTI-AGENT ARTIFICIAL INTELLIGENCE ENVIRONMENT

(71) Applicant: VENKATA SRINIVAS GANTI, Katy, TX (US)

(72) Inventor: VENKATA SRINIVAS GANTI, Katy, TX (US)

(21) Appl. No.: 19/706,306

(22) Filed: Jun. 12, 2026

Related U.S. Application Data
(60) Provisional application No. 64/057,675, filed on May 5, 2026.

(51) Int. Cl. G06F 12/14; G06F 21/30

(52) U.S. Cl. CPC G06F 12/14; G06F 21/30

(57) ABSTRACT

A system for controlling file-writing dispatch in a multi-agent artificial intelligence environment. The system comprises a computing device having a processor, and a memory storing executable instructions. The processor is configured to execute the instructions to implement a pre-dispatch hook engine, a composite write-intent classifier, a dispatch-depth resolver, a protected phase detector, a two-layer enforcement engine, an authorization token validation module, a target agent execution module, a team-mode check module, and a structured response generator. The system prevents recursive or nested dispatch of write-capable agents that may lead to uncontrolled file modifications or system instability. The system provides a controlled authorization mechanism using time-limited tokens for enabling permitted write operations under defined execution conditions. The system ensures that file-writing operations are permitted only within authorized execution contexts associated with specific runtime states, and provides a fail-safe enforcement mechanism that blocks unauthorized or indeterminate write operations to maintain system integrity.

### FIELD OF INVENTION

The present disclosure relates generally to computer-implemented systems for artificial intelligence agent orchestration and runtime control, and more particularly to a system and method for controlling file-writing behavior in multi-agent artificial intelligence environments using pre-dispatch authorization mechanisms, dispatch-depth evaluation, and token-based write control.

### BACKGROUND

Autonomous software engineering systems increasingly rely on multi-agent artificial intelligence architectures in which a primary orchestrator delegates tasks to multiple specialized agents. Such agents may perform read operations or execute write-capable actions including code generation, modification of files, test creation, or artifact updates within a shared development environment. Existing systems implement lifecycle interception mechanisms, such as pre-tool or pre-execution hooks, to regulate agent behavior. For example, existing systems for production AI agent platforms disclose hook-based interception of agent workflows to enforce validation, access control, and confirmation before execution of destructive operations. These approaches provide user-mediated approval mechanisms but depend on interactive confirmation flows and do not inherently analyze agent hierarchy, dispatch relationships, or recursive invocation behavior within multi-agent systems.

Further, known hook configuration systems utilize rule-based filtering and permission decisions (allow, deny, ask, defer) based on tool matching conditions and configuration policies. While such systems provide structured control points for execution, they are generally limited to static rule evaluation and do not dynamically evaluate contextual parameters such as dispatch depth, runtime phase conditions, or implicit write intent derived from task semantics. In addition, file access control techniques in distributed multi-agent environments employ mechanisms such as file locking, optimistic concurrency control, and version validation to prevent concurrent modification conflicts. These approaches address data consistency issues after write operations are initiated, but do not prevent the initiation of unsafe or unauthorized write-capable agent executions, particularly in recursive or nested dispatch scenarios.

Patent literature further discloses token-based authorization mechanisms for AI agents, where execution of agent tasks is gated by authentication tokens issued upon validation of user credentials. For instance, U.S. Pat. No. 1,254,7677 describes pausing agent execution until authentication is completed and a token is obtained to permit further processing. Such systems focus on user-level authentication and credential management, rather than controlling agent-to-agent dispatch behavior or preventing recursive write operations within an orchestration runtime. Similarly, systems for integrating AI agents into software platforms utilize hierarchical access control schemes and credential-based permissions to regulate read and write access to data resources. These approaches govern access at a resource or role level but do not account for dynamic orchestration states such as nested agent invocation, execution phase constraints, or contextual authorization tied to specific dispatch instances. Despite these developments, existing approaches do not adequately address the technical problem of uncontrolled recursive dispatch of write-capable agents in multi-agent artificial intelligence systems. In particular, there remains a lack of mechanisms that evaluate dispatch hierarchy, determine whether the request corresponds to a write-capable operation at runtime, enforce authorization prior to agent execution, and prevent unauthorized file mutations before they occur.

Existing hook-based execution control systems primarily rely upon static permission rules, user-confirmation workflows, or credential validation mechanisms that operate independently of nested dispatch hierarchy and runtime execution context. Such systems do not provide deterministic fail-closed enforcement for recursive write-capable dispatch operations in multi-agent artificial intelligence environments.

Therefore, there exists a need for an improved system and method that provides robust, pre-dispatch control over file-writing operations in multi-agent artificial intelligence environments, while ensuring controlled delegation, preventing recursive write cascades, and maintaining system integrity during execution. There is also a need for a system that provides a two-layer dispatch enforcement architecture configured to evaluate dispatch depth, runtime execution phase, authorization-token validity, and workspace association prior to execution of a write-capable agent. A first control layer performs unconditional blocking of nested write-capable dispatch operations independent of downstream authorization outcomes. A second control layer performs protected-phase enforcement using bounded token validation and execution-context authorization. There is further a need for a system that introduces fail-closed marker validation in which malformed, corrupted, expired, indeterminate, or unauthorized dispatch metadata automatically results in assignment of a restricted nested-dispatch state. The present disclosure additionally supports conditional workspace-bound authorization validation and bounded token lifetime enforcement to prevent unauthorized cross-workspace write execution. There is a need for a system that improves runtime execution integrity, prevents uncontrolled recursive file mutation, and enhances deterministic enforcement control within multi-agent artificial intelligence orchestration environments.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to a system for controlling file-writing dispatch in a multi-agent artificial intelligence environment. The system comprises a computing device having a processor, and a memory coupled to the processor and storing executable instructions. The processor is configured to execute the instructions to implement a pre-dispatch hook engine, a composite write-intent classifier, a dispatch-depth resolver, a protected phase detector, a two-layer enforcement engine, an authorization token validation module, a target agent execution module, a team-mode check module, and a structured response generator.

In one embodiment, the pre-dispatch hook engine is configured to intercept a request to dispatch a target agent prior to execution of the target agent. The pre-dispatch hook engine is integrated within an agent orchestration runtime.

In one embodiment, the composite write-intent classifier is configured to classify the request to determine whether the request corresponds to a write-capable operation, based on a write-intent determination. The composite write-intent classifier evaluates membership of the target agent in a registry of write-capable agent types and one or more natural-language signals associated with a task prompt. The composite write-intent classifier comprises a predefined negative list of read-only agent types. The processor is configured to permit execution of requests corresponding to the read-only agent types independent of the write-intent determination.

In one embodiment, the dispatch-depth resolver is configured to determine a dispatch depth associated with the request, to evaluate runtime state information and at least one persistent marker artifact. The dispatch-depth resolver is configured to determine the dispatch depth using a prioritized evaluation of a caller-supplied depth parameter, a runtime-state dispatch-depth field, and the persistent marker artifact. The dispatch-depth resolver assigns a restricted nested-dispatch state when the persistent marker artifact is present but invalid, thereby implementing a fail-closed behavior. The prioritized evaluation performed by the dispatch-depth resolver comprises sequential fallback evaluation of a caller-supplied depth parameter, the runtime-state dispatch-depth field, a legacy dispatch-depth parameter, the persistent marker artifact, and a restricted nested-dispatch fallback state applied upon validation failure of the persistent marker artifact.

In one embodiment, the protected phase detector is configured to determine whether a protected execution phase is active based on persisted runtime state.

In one embodiment, the two-layer enforcement engine is configured to enforce a first control layer configured to block the request when the request corresponds to the write-capable operation and the dispatch depth indicates nested dispatch. The nested dispatch corresponds to a dispatch depth value of at least two. Further, the two-layer enforcement engine enforces a second control layer configured to block the request during the protected execution phase unless a valid authorization token is present. The two-layer enforcement engine is configured such that the first control layer is applied prior to the second control layer such that nested write-capable dispatch requests are blocked irrespective of validity of the authorization token.

In one embodiment, the protected execution phase comprises at least one of a test-authoring phase, a code-implementation phase, or a remediation phase, and write-capable operations are restricted during the protected execution phase in absence of a valid authorization token.

In one embodiment, the protected execution phase comprises at least one of a red phase corresponding to test-authoring operations, a green phase corresponding to code-implementation operations, or a fix phase corresponding to remediation operations, and write-capable operations are restricted during the protected execution phase in absence of a valid authorization token.

In operation, the pre-dispatch hook engine intercepts the request, after which the composite write-intent classifier determines write intent. The dispatch-depth resolver determines a dispatch depth associated with the request, and the protected phase detector determines whether the protected execution phase is active. The authorization token validation module validates the authorization token, and the two-layer enforcement engine applies the first control layer and the second control layer to determine whether to permit or block execution of the target agent.

In one embodiment, the authorization token validation module is configured to validate the authorization token based on at least a creation timestamp and a time-to-live constraint. The authorization token optionally comprises a workspace identifier derived from a working directory. The authorization token validation module is configured to validate the workspace identifier against a current execution workspace when the workspace identifier is present within the authorization token.

In one embodiment, the authorization token validation module validates the authorization token based on a time validity condition defined as a minimum of a declared time-to-live associated with the token and a predefined maximum time window enforced by the system.

The second control layer is applied based on a validation result obtained from the authorization token validation module.

In one embodiment, the target agent execution module is configured to permit or block execution of the target agent prior to file-system mutation based on outcomes of the first control layer and the second control layer. The system prevents unauthorized file-writing operations at a pre-execution stage, thereby improving integrity of the multi-agent execution environment.

In one embodiment, the team-mode check module is configured to determine, prior to enforcement, whether execution occurs in independent sessions, and to bypass the first control layer and the second control layer when the runtime state indicates independent execution.

In one embodiment, the structured response generator is configured to generate a structured rejection response upon blocking the request. The structured rejection response indicates at least one of a control layer responsible for blocking, and a corrective action for enabling authorized execution.

An embodiment of the first aspect, a method for controlling file-writing dispatch in a multi-agent artificial intelligence environment using the system. First, an agent dispatch request is received. Next, the request is intercepted by a pre-dispatch hook engine prior to execution of a target agent.

Next, a determination is made, using the team-mode check module, as to whether a team-mode execution condition is active based on a runtime state information. Next, when the team-mode execution condition is active, the request is permitted and dispatch of the target agent proceeds via a target agent execution module. Next, when the team-mode execution condition is not active, a determination is made, using the composite write-intent classifier, as to whether the target agent corresponds to a read-only agent type based on a predefined negative list.

Next, when the target agent corresponds to the read-only agent type, the request is permitted and dispatch proceeds via the target agent execution module. Next, when the target agent does not correspond to the read-only agent type, a write-intent classification is performed using the composite write-intent classifier. The classification evaluates at least a registry of write-capable agent types and one or more natural-language signals associated with a task prompt.

Next, a determination is made as to whether the request corresponds to the write-capable operation. When the request does not correspond to the write-capable operation, the request is permitted and dispatch proceeds via the target agent execution module. Next, when the request corresponds to the write-capable operation, a dispatch depth associated with the request is determined using the dispatch-depth resolver based on runtime state information and at least one marker artifact.

Next, the first control layer is applied using the two-layer enforcement engine by determining whether the dispatch depth meets or exceeds a dispatch depth value of at least two, or another predefined nested-dispatch threshold. Next, when the dispatch depth meets or exceeds the threshold, the request is blocked to prevent nested write-capable execution, and a structured rejection response is generated using the structured response generator.

Next, when the dispatch depth does not meet the threshold, a determination is made, using the protected phase detector, as to whether the protected execution phase is active based on runtime state. Next, when the protected execution phase is not active, the request is permitted and dispatch proceeds via the target agent execution module.

Next, when the protected execution phase is active, a determination is made, using the authorization token validation module, as to whether an authorization token is valid. The validity is determined based on at least a creation timestamp, a time validity condition, and, when a workspace identifier is present within the authorization token, validation of the workspace identifier against a current execution workspace. Next, when the authorization token is valid, the request is permitted and dispatch proceeds via the target agent execution module. Later, when the authorization token is not valid, the request is blocked by the two-layer enforcement engine to prevent unauthorized file-writing during the protected execution phase, and a structured rejection response is generated using the structured response generator.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a block diagram of a system for controlling file-writing dispatch in a multi-agent artificial intelligence environment, in accordance with embodiments of the invention.

FIG. 2 illustrates a flowchart of a method for controlling file-writing dispatch in a multi-agent artificial intelligence environment using the system, in accordance with embodiments of the invention.

FIG. 3 illustrates a sequence diagram for generation, validation, and enforcement of an authorization token in a multi-agent artificial intelligence environment using the system, in accordance with embodiments of the invention.

FIG. 4 illustrates a fail-closed dispatch-depth resolution flowchart for determining a dispatch depth associated with a request using the dispatch-depth resolver executed by the processor of the computing device within the system, in accordance with embodiments of the invention.

FIG. 5 illustrates a control flow diagram depicting enforcement of a depth-based restriction mechanism for preventing nested dispatch of write-capable agents within the system, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

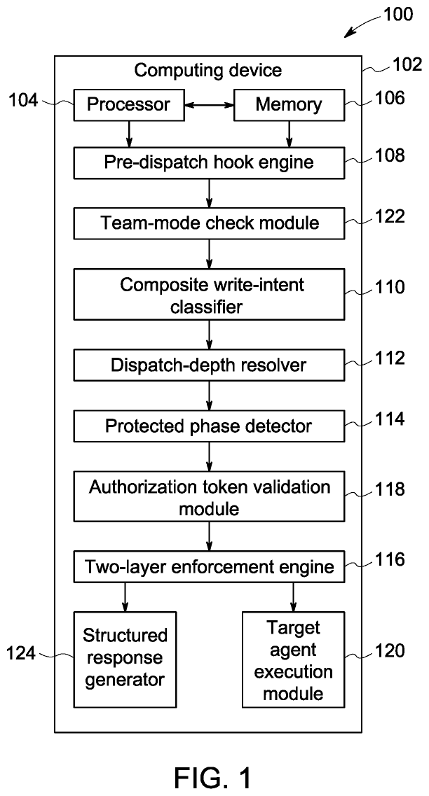

FIG. 1 illustrates a block diagram of a system 100 for controlling file-writing dispatch in a multi-agent artificial intelligence environment. The system 100 comprises a computing device 102 having a processor 104, and a memory 106 coupled to the processor 104 and storing executable instructions. The processor 104 is configured to execute the instructions to implement a pre-dispatch hook engine 108, a composite write-intent classifier 110, a dispatch-depth resolver 112, a protected phase detector 114, a two-layer enforcement engine 116, an authorization token validation module 118, a target agent execution module 120, a team-mode check module 122, and a structured response generator 124. The system 100 improves operation of a computing environment by preventing execution of unsafe recursive agent processes and reducing unintended file-system mutations at a pre-execution stage.

The processor 104 is configured to coordinate execution of the pre-dispatch hook engine 108, the composite write-intent classifier 110, the dispatch-depth resolver 112, the protected phase detector 114, the two-layer enforcement engine 116, the authorization token validation module 118, the target agent execution module 120, the team-mode check module 122, and the structured response generator 124 to control dispatch of a target agent in a multi-agent artificial intelligence environment. The processor 104 performs interception of dispatch requests, classification of write intent, determination of dispatch depth, detection of execution phases, validation of authorization tokens, and enforcement of execution control based on defined runtime state, dispatch-depth, and token-validation conditions.

In one embodiment, the pre-dispatch hook engine 108, the composite write-intent classifier 110, the dispatch-depth resolver 112, the protected phase detector 114, the two-layer enforcement engine 116, the authorization token validation module 118, the target agent execution module 120, the team-mode check module 122, and the structured response generator 124 each correspond to processor-executable control structures implemented using executable instruction sequences, state-evaluation routines, deterministic decision logic, structured data parsers, runtime-state traversal operations, hash-computation operations, token-validation procedures, graph-analysis operations, or rule-evaluation workflows stored in the memory 106 and executed by the processor 104. The processor 104 executes ordered computational operations associated with the respective modules to transform runtime execution data into dispatch-control decisions that govern execution of target agents prior to file-system mutation.

The memory 106 stores program instructions, runtime state information, and one or more persistent marker artifacts used by the dispatch-depth resolver 112 and the protected phase detector 114. The memory 106 further stores token data associated with authorization tokens validated by the authorization token validation module 118.

The computing device 102 comprises any processing system configured to execute the instructions stored in the memory 106, including but not limited to a server system, a workstation, a cloud-based computing instance, or a distributed processing node configured to support execution of agent orchestration workflows.

In one embodiment, the system 100 operates within or in communication with an agent orchestration runtime environment, wherein the pre-dispatch hook engine 108 is integrated to intercept agent dispatch requests prior to execution, and the two-layer enforcement engine 116 is configured to control execution based on dispatch depth and execution phase conditions.

In one embodiment, the pre-dispatch hook engine 108 is configured to intercept a request to dispatch the target agent prior to execution of the target agent. The pre-dispatch hook engine 108 is integrated within an agent orchestration runtime.

In one embodiment, the composite write-intent classifier 110 is configured to classify the request to determine whether the request corresponds to a write-capable operation, based on a write-intent determination. The write intent refers to a classification indicating that a request corresponds to a write-capable operation involving modification of persistent data. The composite write-intent classifier 110 evaluates membership of the target agent in a registry of write-capable agent types, and one or more natural-language signals associated with a task prompt. The composite write-intent classifier 110 comprises a predefined negative list of read-only agent types. The processor 104 is configured to permit execution of requests corresponding to the read-only agent types independent of the write-intent determination.

In one embodiment, the composite write-intent classifier 110 is configured to determine whether the request corresponds to a write-capable operation using one or more alternative detection mechanisms including static analysis of execution instructions, semantic parsing of agent-generated plans, tool invocation pattern recognition, behavioral profiling of prior agent actions, or machine learning-based classification models trained to identify write-capable operations. The processor 104 is configured to aggregate outputs from such mechanisms to improve robustness of write-intent determination and to prevent circumvention through obfuscation or indirect specification of write-capable actions.

In one embodiment, the composite write-intent classifier 110 is implemented as a multi-signal evaluation module configured to determine whether a dispatch request corresponds to a write-capable operation by combining a plurality of heterogeneous classification inputs. The composite write-intent classifier 110 is executed by the processor 104 and operates on data associated with a dispatch request intercepted by the pre-dispatch hook engine 108.

The composite write-intent classifier 110 comprises a registry evaluation component configured to determine whether a target agent associated with the dispatch request is included in a predefined registry of write-capable agent types. The registry is stored in the memory 106 as a canonical data structure and comprises identifiers corresponding to agent types capable of performing file mutation operations, including creation, modification, deletion, or relocation of persistent artifacts.

The composite write-intent classifier 110 further comprises a natural-language signal evaluation component configured to analyze a task prompt associated with the dispatch request. The natural-language signal evaluation component applies one or more pattern-matching operations, including regular expression evaluation, semantic parsing, or keyword detection, to identify linguistic indicators of write-capable operations. Such indicators include command verbs, file path expressions, or syntactic constructs associated with generation, modification, or persistence of data.

In addition, the composite write-intent classifier 110 comprises a negative-list evaluation component configured to identify whether the target agent corresponds to a read-only agent type included in a predefined negative list. The negative list is stored in the memory 106 and comprises identifiers corresponding to agents restricted to non-mutative operations, including exploration, planning, analysis, or data retrieval tasks. When the target agent is identified as belonging to the negative list, the processor 104 is configured to classify the dispatch request as lacking write intent irrespective of outputs of the registry evaluation component and the natural-language signal evaluation component.

The processor 104 is configured to aggregate outputs of the registry evaluation component, the natural-language signal evaluation component, and the negative-list evaluation component to generate a composite write-intent determination. In one embodiment, the composite write-intent classifier 110 applies a priority rule in which identification of a negative-list agent overrides positive write-intent signals, thereby ensuring that read-only agents are permitted to execute without restriction.

In one embodiment, the composite write-intent classifier 110 is configured to classify a dispatch request as corresponding to a write-capable operation when at least one of the registry evaluation component or the natural-language signal evaluation component produces a positive write-intent indication, and the negative-list evaluation component does not identify the target agent as a read-only agent. The processor 104 is configured to output a binary write-intent classification result used by the two-layer enforcement engine 116 to determine whether enforcement conditions are to be applied. The two-layer enforcement engine 116 comprises a first-layer enforcement module and a second-layer enforcement module.

In one embodiment, the composite write-intent classifier 110 is configured to operate in conjunction with the protected phase detector 114 and the dispatch-depth resolver 112, such that classification outputs are evaluated in combination with runtime state information to determine whether a dispatch request is permitted or blocked prior to execution of a target agent.

The composite write-intent classifier 110 is configured to evaluate agent identity and task semantics concurrently, thereby preventing circumvention through use of non-registry agent types or obfuscated natural-language prompts.

In one embodiment, the dispatch-depth resolver 112 is configured to determine a dispatch depth associated with the request, to evaluate runtime state information and at least one persistent marker artifact. The dispatch-depth resolver 112 is configured to determine the dispatch depth using a prioritized evaluation of a caller-supplied depth parameter, a runtime-state dispatch-depth field, and the persistent marker artifact. The dispatch-depth resolver 112 assigns a restricted nested-dispatch state when the persistent marker artifact is present but invalid, thereby implementing a fail-closed behavior.

In one embodiment, the prioritized evaluation performed by the dispatch-depth resolver 112 comprises sequential fallback evaluation of a caller-supplied depth parameter, the runtime-state dispatch-depth field, a legacy dispatch-depth parameter, the persistent marker artifact, and a restricted nested-dispatch fallback state applied upon validation failure of the persistent marker artifact.

In one embodiment, the dispatch-depth resolver 112 executes an ordered hierarchy-evaluation workflow comprising parsing the caller-supplied depth parameter, evaluating runtime-state metadata associated with a current execution session, evaluating one or more persistent marker artifacts stored within a filesystem or runtime datastore, validating structural integrity and parseability of marker-associated data, and assigning the restricted nested-dispatch state when validation fails. The dispatch-depth resolver 112 thereby implements a deterministic fail-closed computational workflow for hierarchical dispatch evaluation.

In one embodiment, a fail-closed enforcement condition corresponds to an execution-control state in which file-writing dispatch operations are denied by default unless validation of dispatch depth, authorization state, marker integrity, runtime context, and execution conditions succeeds. The fail-closed enforcement condition prevents recursive write-capable execution when dispatch metadata is malformed, corrupted, indeterminate, expired, missing, or otherwise invalid.

In one embodiment, the protected phase detector 114 is configured to determine whether a protected execution phase is active based on persisted runtime state.

In one embodiment, the two-layer enforcement engine 116 is configured to enforce a first control layer configured to block the request when the request corresponds to the write-capable operation and the dispatch depth indicates nested dispatch. The nested dispatch corresponds to a dispatch depth value of at least two. Further, the two-layer enforcement engine 116 enforces a second control layer configured to block the request during the protected execution phase unless a valid authorization token is present. The two-layer enforcement engine 116 is configured such that the first control layer is applied prior to the second control layer such that nested write-capable dispatch requests are blocked irrespective of validity of the authorization token.

In one embodiment, the protected execution phase comprises at least one of a red phase corresponding to test-authoring operations, a green phase corresponding to code-implementation operations, or a fix phase corresponding to remediation operations, and write-capable operations are restricted during the protected execution phase in absence of a valid authorization token.

In operation, the pre-dispatch hook engine 108 intercepts the request, after which the composite write-intent classifier 110 determines write intent. The dispatch-depth resolver 112 determines a dispatch depth associated with the request, and the protected phase detector 114 determines whether the protected execution phase is active. The authorization token validation module 118 validates the authorization token, and the two-layer enforcement engine 116 applies the first control layer and the second control layer to determine whether to permit or block execution of the target agent.

In one embodiment, the authorization token validation module 118 is configured to validate the authorization token based on at least a creation timestamp and a time-to-live constraint. The authorization token optionally comprises a workspace identifier derived from a working directory. The authorization token validation module 118 is configured to validate the workspace identifier against a current execution workspace when the workspace identifier is present within the authorization token. The authorization token validation module 118 validates the authorization token using a bounded time-validity condition in which a default token time-to-live value corresponds to five seconds and is clamped to a predefined maximum ceiling of sixty seconds irrespective of a larger declared token lifetime. The processor 104 is configured to invalidate authorization tokens exceeding the predefined maximum ceiling, thereby preventing stale authorization reuse and reducing unauthorized write-capable execution in prolonged runtime sessions.

In one embodiment, workspace association validation is conditionally applied when a workspace identifier is present within the authorization token. The processor 104 validates the workspace identifier against a current execution workspace prior to permitting write-capable execution.

In another embodiment, workspace association validation is selectively bypassed when the authorization token does not include a workspace identifier, thereby maintaining compatibility with legacy execution environments lacking workspace-bound authorization support.

In one embodiment, the authorization token validation module 118 validates the authorization token based on a time validity condition defined as a minimum of a declared time-to-live associated with the token and a predefined maximum time window enforced by the system 100.

The second control layer is applied based on a validation result obtained from the authorization token validation module 118.

In one embodiment, the authorization token validation module 118 is configured to validate authorization using one or more alternative authorization mechanisms in addition to or in place of a token-based scheme. Such mechanisms include capability flags associated with the target agent, role-based access credentials, policy-derived execution permissions, cryptographic validation data, or dynamically evaluated authorization states derived from runtime conditions. The processor 104 is configured to evaluate such authorization states in conjunction with the two-layer enforcement engine 116 to determine whether the request corresponds to a permitted write-capable operation. This enables enforcement of execution control independent of a specific token format, thereby preventing circumvention through substitution of alternative authorization representations.

In one embodiment, the target agent execution module 120 is configured to permit or block execution of the target agent prior to file-system mutation based on outcomes of the first control layer and the second control layer. The system 100 prevents unauthorized file-writing operations at a pre-execution stage, thereby improving integrity of the multi-agent execution environment.

In one embodiment, the team-mode check module 122 is configured to determine, prior to enforcement, whether execution occurs in independent sessions. Independent sessions correspond to execution contexts lacking shared write access, shared persistent-storage mutation capability, shared repository modification capability, shared deployment propagation capability, shared runtime execution lineage, or coordinated persistent-state modification capability associated with a common execution environment. The processor 104 is configured to maintain enforcement of the first control layer and the second control layer when logically separate execution sessions remain capable of producing shared file-system mutations, deployment cascades, repository modifications, inter-process mutation propagation, or coordinated persistent-state modification within the common execution environment.

In one embodiment, the structured response generator 124 is configured to generate a structured rejection response upon blocking the request. The structured rejection response indicates at least one of a control layer responsible for blocking, and a corrective action for enabling authorized execution.

The system 100 enforces execution control at a pre-dispatch stage within a runtime environment, thereby modifying operation of the computing system itself rather than merely evaluating abstract decision logic.

In one embodiment, the system 100 is configured to manage a lifecycle of authorization tokens including generation, validation, propagation, and revocation. The processor 104, in coordination with the authorization token validation module 118, is configured to generate authorization tokens upon satisfaction of predefined conditions, associate tokens with specific execution contexts, and revoke or invalidate tokens upon expiration, completion of execution, or detection of anomalous behavior. The memory 106 is configured to store token state information including issuance timestamps, usage history, and revocation indicators. The two-layer enforcement engine 116 is configured to deny execution when a token is determined to be revoked or otherwise invalid, thereby enhancing control over write-capable operations across multiple execution cycles.

In one embodiment, the system 100 is implemented in a distributed computing architecture in which one or more of the pre-dispatch hook engine 108, the dispatch-depth resolver 112, the protected phase detector 114, and the two-layer enforcement engine 116 are executed across multiple computing nodes. The computing device 102 is configured to communicate with remote nodes via a network, wherein runtime state information, marker artifacts, and authorization data are synchronized across the nodes. The processor 104 is configured to coordinate enforcement decisions across the nodes to maintain consistency of dispatch control in multi-session and distributed agent execution environments.

In one embodiment, the dispatch-depth resolver 112 is configured to determine dispatch depth using alternative representations of execution hierarchy including call stack inspection, parent-child execution tracing, session lineage tracking, or graph-based representations of agent interactions. The processor 104 is configured to compute dispatch depth based on such representations to identify nested dispatch conditions even when explicit depth parameters or marker artifacts are absent, thereby preventing circumvention through alternative execution tracking mechanisms.

In one embodiment, the system 100 maintains an execution graph representing relationships between agents involved in dispatch operations. The memory 106 is configured to store data structures representing nodes corresponding to agents and edges corresponding to dispatch relationships. The processor 104 is configured to analyze the execution graph to determine hierarchical relationships, detect recursive invocation patterns, and support computation of dispatch depth by the dispatch-depth resolver 112. Such graph-based modeling enhances accuracy of nested dispatch detection and enables enforcement across complex multi-agent interaction scenarios.

In one embodiment, the two-layer enforcement engine 116 is configured to enforce execution control at multiple stages including pre-dispatch, mid-execution, and post-execution stages. The processor 104 may prevent execution at a pre-dispatch stage, interrupt execution at a mid-execution stage upon detection of a violation condition, or perform post-execution validation to identify and revert unauthorized file-system modifications. Such multi-stage enforcement improves robustness of control and reduces risk of unintended system modifications in dynamic execution environments.

In one embodiment, the two-layer enforcement engine 116 is configured to operate in conjunction with a policy definition framework stored in the memory 106. The processor 104 is configured to evaluate enforcement conditions based on policy rules that define allowable execution behavior, authorization requirements, and threshold parameters. The policy rules may be dynamically updated to reflect system configuration changes, user preferences, or organizational requirements, thereby enabling adaptive control of agent execution without modification of underlying execution logic.

In one embodiment, the system 100 is configured to associate each target agent with an identity comprising one or more of a unique agent identifier, session identifier, execution context identifier, or derived identity value. The processor 104 is configured to track such identities across dispatch operations to determine relationships between agents and to support accurate identification of nested dispatch conditions. The identity information is used by the dispatch-depth resolver 112 and the two-layer enforcement engine 116 to enforce execution control based on agent relationships and execution context.

In one embodiment, the system 100 operates in a hybrid execution environment in which portions of the processing are performed locally on the computing device 102 and portions are performed on a remote computing system. The pre-dispatch hook engine 108 may be executed locally to intercept requests with minimal latency, while the authorization token validation module 118 and the two-layer enforcement engine 116 are executed remotely to enforce centralized control. The processor 104 is configured to coordinate communication between local and remote components to ensure consistent enforcement across execution environments.

The system 100 improves operation of a computing system by modifying execution behavior at a pre-dispatch stage, thereby preventing unsafe recursive execution of agent processes and reducing unintended file-system mutations. The coordinated operation of the pre-dispatch hook engine 108, the dispatch-depth resolver 112, the protected phase detector 114, and the two-layer enforcement engine 116 enables the processor 104 to enforce execution constraints based on runtime conditions, thereby enhancing system stability, reducing resource contention, and improving integrity of persistent data within the computing environment.

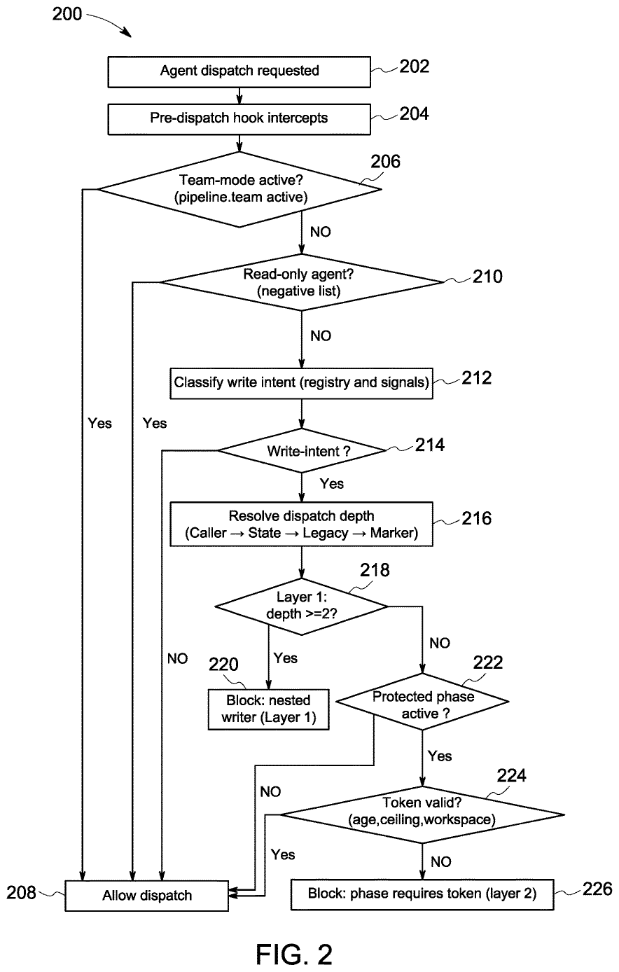

FIG. 2 illustrates a flowchart 200 of a method for controlling file-writing dispatch in a multi-agent artificial intelligence environment using the system 100. At step 202, an agent dispatch request is received. At step 204, the request is intercepted by a pre-dispatch hook engine 108 prior to execution of a target agent.

At step 206, a determination is made, using the team-mode check module 122, as to whether a team-mode execution condition is active based on a runtime state information. When the team-mode execution condition is active, the request is permitted and dispatch of the target agent proceeds via a target agent execution module 120, as depicted at step 208. When the team-mode execution condition is not active, a determination is made, using the composite write-intent classifier 110, as to whether the target agent corresponds to a read-only agent type based on a predefined negative list, as depicted at step 210.

When the target agent corresponds to the read-only agent type, the request is permitted and dispatch proceeds via the target agent execution module 120, as depicted at step 208. When the target agent does not correspond to the read-only agent type, a write-intent classification is performed using the composite write-intent classifier 110, as depicted at step 212. The classification evaluates at least a registry of write-capable agent types and one or more natural-language signals associated with a task prompt. The natural-language signals include command verbs, semantic intent classification, or prompt-derived action indicators.

At step 214, a determination is made as to whether the request corresponds to the write-capable operation. When the request does not correspond to the write-capable operation, the request is permitted and dispatch proceeds via the target agent execution module 120.

At step 216, when the request corresponds to the write-capable operation, a dispatch depth associated with the request is determined using the dispatch-depth resolver 112 based on runtime state information and at least one marker artifact. The runtime state includes execution phase indicators, session identifiers, dispatch context metadata, or agent hierarchy state.

At step 218, the first control layer is applied using the two-layer enforcement engine 116 by determining whether the dispatch depth meets or exceeds a dispatch depth value of at least two, or another predefined nested-dispatch threshold. When the dispatch depth meets or exceeds the threshold, the request is blocked to prevent nested write-capable execution, and a structured rejection response is generated using the structured response generator 124, as depicted at step 220.

When the dispatch depth does not meet the threshold, a determination is made, using the protected phase detector 114, as to whether a protected execution phase is active based on runtime state, as depicted at step 222.

When the protected execution phase is not active, the request is permitted and dispatch proceeds via the target agent execution module 120, as depicted at step 208.

At step 224, when the protected execution phase is active, a determination is made, using the authorization token validation module 118, as to whether an authorization token is valid. The validity is determined based on at least a creation timestamp, a time validity condition, and, when a workspace identifier is present within the authorization token, validation of the workspace identifier against a current execution workspace.

When the authorization token is valid, the request is permitted and dispatch proceeds via the target agent execution module 120, as depicted at step 208.

At step 226, when the authorization token is not valid, the request is blocked by the two-layer enforcement engine 116 to prevent unauthorized file-writing during the protected execution phase, and a structured rejection response is generated using the structured response generator 124.

The method executed by the system 100 thereby ensures that write-capable operations are controlled prior to execution by applying depth-based and phase-based enforcement, thereby preventing unauthorized modification of persistent data and improving integrity of the multi-agent execution environment.

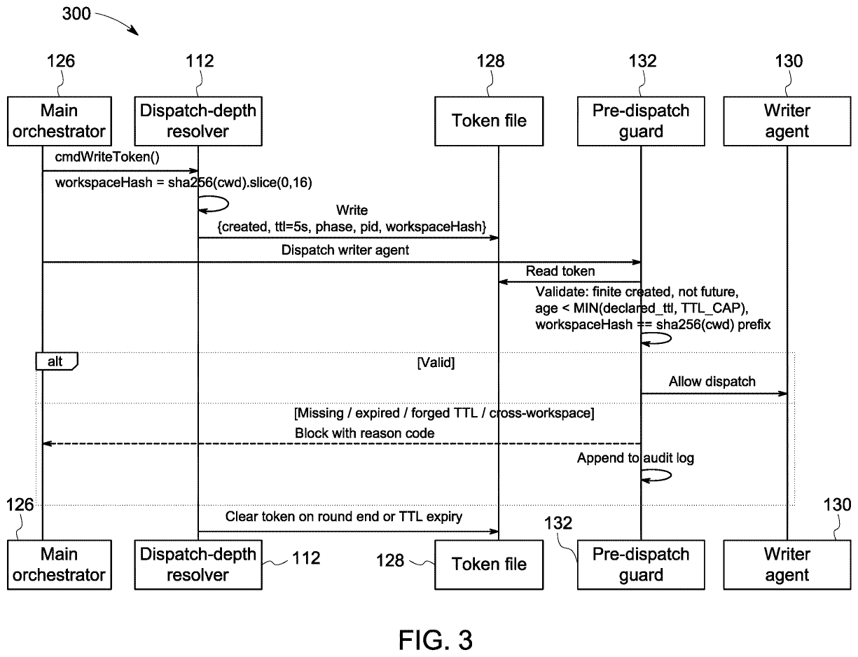

FIG. 3 illustrates a sequence diagram 300 for generation, validation, and enforcement of an authorization token in a multi-agent artificial intelligence environment using the system 100. A command to generate an authorization token is initiated by a controlling entity implemented within the system 100, corresponding to a main orchestrator 126. The main orchestrator 126 is executed by the computing device 102 using the processor 104 or is configured to communicate with the system 100. The dispatch-depth resolver 112 derives the workspace identifier by computing a hash value based on a working directory associated with an execution environment. The processor 104, in coordination with the authorization token validation module 118, performs token generation. The token data comprises at least a creation timestamp, a time-to-live parameter, an execution phase indicator, and a process identifier, and optionally comprises a workspace identifier associated with the execution environment. The processor 104 stores the token data in a token data store 128 accessible to the pre-dispatch hook engine 108 and the authorization token validation module 118. The token data may be stored in a file, in-memory structure, distributed storage system, or secure runtime cache. A request to dispatch a target agent, shown as writer agent 130, is initiated, and the request is intercepted by the pre-dispatch hook engine 108 prior to execution of the target agent.

In one embodiment, the workspace identifier is generated by applying a SHA-256 hashing operation to a workspace path, working directory identifier, repository identifier, or execution-context location. The resulting hash value is truncated to a sixteen-hex-character prefix for storage and validation within the authorization token. The truncated workspace hash enables lightweight execution-context binding while reducing token-processing overhead during runtime authorization validation.

A pre-dispatch guard 132 represents control logic implemented by the pre-dispatch hook engine 108, the authorization token validation module 118, and the two-layer enforcement engine 116. A validation operation is performed by pre-dispatch control logic implemented by the pre-dispatch hook engine 108, the authorization token validation module 118, and the two-layer enforcement engine 116. The authorization token validation module 118 reads the token data from the token data store 128 and evaluates validity based on a plurality of conditions including a finite creation timestamp, absence of future-dated values, a time validity condition defined as a minimum of a declared time-to-live and a predefined maximum time window, and, when a workspace identifier is present within the authorization token, validation of the workspace identifier against a current execution workspace.

In one embodiment, authorization-token validation comprises execution of a bounded validation workflow including extraction of token-associated timestamp data, computation of an effective validity duration using a minimum comparison between a declared token lifetime and a predefined maximum validity ceiling, validation of execution-phase association, validation of workspace association using hash-derived execution-context identifiers, and generation of a validation outcome used by the two-layer enforcement engine 116 to permit or block execution of the target agent.

When a workspace identifier is present within the authorization token, the authorization token validation module 118 further determines whether the workspace identifier associated with the token matches a hash prefix derived from the working directory, thereby ensuring that the token is valid only within an authorized execution context.

When the authorization token satisfies the validation conditions, the two-layer enforcement engine 116 permits dispatch of the target agent via the target agent execution module 120. When the authorization token is missing, expired, malformed, otherwise invalid, or, when a workspace identifier is present, associated with a different workspace, including a token having an over-long time-to-live, a stale token, a malformed token, or a cross-workspace token, the two-layer enforcement engine 116 blocks the request and generates a rejection response via the structured response generator 124, indicating a reason for blocking. Upon blocking of the request, an audit entry is generated and appended to a log to record the validation outcome and enforcement decision. The token data store 128 is cleared upon completion of an execution cycle or upon expiration of the time-to-live parameter to prevent reuse of stale tokens. The method executed by the system 100 thereby ensures that write-capable operations are permitted only when a valid authorization token is present, thereby preventing unauthorized file-writing operations and improving integrity and security of the multi-agent execution environment.

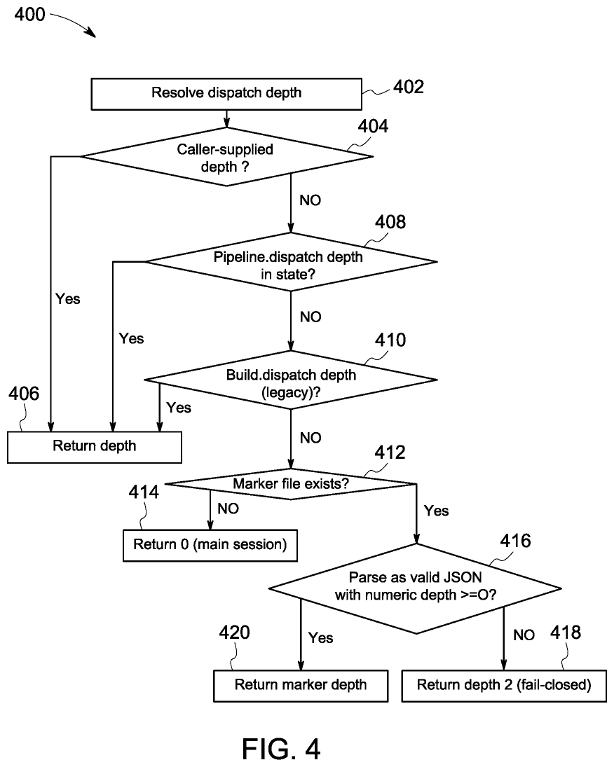

FIG. 4 illustrates a fail-closed dispatch-depth resolution flowchart 400 of a method for determining a dispatch depth associated with a request using the dispatch-depth resolver 112 executed by the processor 104 of the computing device 102 within the system 100. The method begins at step 402, where the dispatch-depth resolver 112 receives a request to determine a dispatch depth associated with a target agent dispatch intercepted by the pre-dispatch hook engine 108. At step 404, the dispatch-depth resolver 112 determines whether a caller-supplied depth parameter is available within the request. When the caller-supplied depth parameter is available, the dispatch-depth resolver 112 determines the dispatch depth based on the caller-supplied depth parameter and returns the dispatch depth for use by the two-layer enforcement engine 116, as depicted at step 406.

At step 408, when the caller-supplied depth parameter is not available, the dispatch-depth resolver 112 determines whether a dispatch depth value is present in a runtime state information associated with the system 100. When the dispatch depth value is present in the runtime state information, the dispatch-depth resolver 112 determines the dispatch depth based on the runtime state information and returns the dispatch depth for use by the two-layer enforcement engine 116, as depicted at step 406. When the dispatch depth value is not present in the runtime state information, the dispatch-depth resolver 112 determines whether a legacy dispatch depth parameter is available, as depicted at step 410.

When the legacy dispatch depth parameter is available, the dispatch-depth resolver 112 determines the dispatch depth based on the legacy dispatch depth parameter and returns the dispatch depth for use by the two-layer enforcement engine 116 as depicted at step 406. At step 412, when the legacy dispatch depth parameter is not available, the dispatch-depth resolver 112 determines whether a marker file corresponding to a persistent marker artifact is present in a storage accessible to the computing device 102. The persistent marker artifact includes a file, flag, metadata record, or serialized state object indicating prior dispatch activity.

At step 414, when the marker file is not present, the dispatch-depth resolver 112 returns a dispatch depth value of zero corresponding to a main execution context for subsequent evaluation by the two-layer enforcement engine 116. At step 416, when the marker file is present, the dispatch-depth resolver 112 determines whether the marker file can be parsed as valid structured data comprising a numeric dispatch depth value greater than or equal to zero. At step 420, when the marker file is successfully parsed and contains a valid numeric dispatch depth value, the dispatch-depth resolver 112 returns the marker-derived dispatch depth for use by the two-layer enforcement engine 116. At step 418, when the marker file cannot be parsed or does not contain a valid numeric dispatch depth value, the dispatch-depth resolver 112 applies a fail-closed condition by returning a predefined nested-dispatch depth value corresponding to a restricted execution state, such that the request is treated as nested dispatch by the two-layer enforcement engine 116.

The method executed by the dispatch-depth resolver 112 thereby ensures that dispatch depth is determined using prioritized evaluation of the caller-supplied depth parameter, the runtime state information, the legacy parameter, and the persistent marker artifact, and that invalid or corrupted marker data results in a fail-closed response to prevent unsafe nested execution and unauthorized file-writing operations within the system 100.

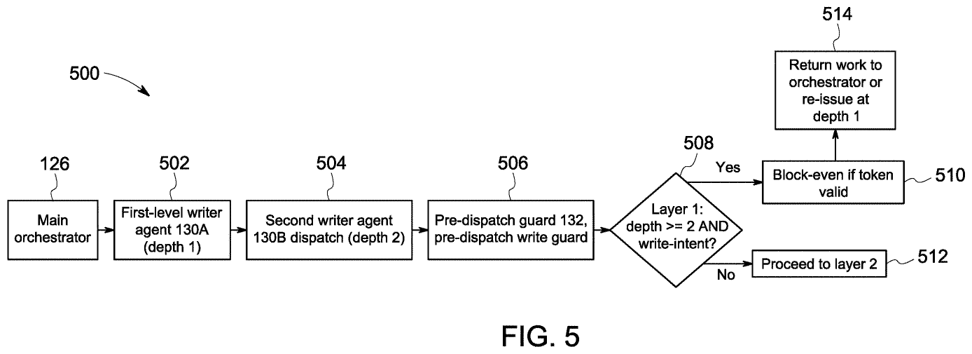

FIG. 5 illustrates a control flow diagram 500 depicting enforcement of a depth-based restriction mechanism for preventing nested dispatch of write-capable agents within the system 100. At step 502, the main orchestrator 126 initiates a dispatch of a first-level writer agent 130A operating at a dispatch depth of one. At step 504, the first-level writer agent 130A subsequently attempts to dispatch a second writer agent 130B, thereby forming a nested dispatch request associated with a dispatch depth greater than or equal to two. At step 506, the nested dispatch request is intercepted by the pre-dispatch guard 132, implemented as part of the pre-dispatch hook engine 108 executed by the processor 104 of the computing device 102. The pre-dispatch guard 132 evaluates the intercepted request prior to execution of the second writer agent 130B. The blocking operation is performed prior to invocation of the second writer agent 130B, thereby preventing initiation of file-system mutation.

The pre-dispatch guard 132 invokes a depth evaluation operation using the dispatch-depth resolver 112 to determine whether the dispatch depth associated with the request meets or exceeds a predefined nested-dispatch threshold. In the illustrated embodiment, the threshold corresponds to a dispatch depth value of two or greater.

The pre-dispatch guard 132 further evaluates whether the intercepted request corresponds to a write-capable operation using the composite write-intent classifier 110. The composite write-intent classifier 110 determines write intent based on registry membership, natural-language signals, and negative-list evaluation as previously described. The pre-dispatch guard 132 provides the evaluated parameters to a first-layer enforcement module of the two-layer enforcement engine 116. At step 508, the first-layer enforcement module applies a depth-based enforcement condition defined as blocking the request when the dispatch depth meets or exceeds a predefined nested-dispatch threshold and the request corresponds to a write-capable operation:

dispatch depth≥2∧write intent detected

At step 510, when the enforcement condition is satisfied, the processor 104 blocks execution of the nested dispatch request directed to the second writer agent 130B.

Importantly, the first-layer enforcement module is configured to operate as a short-circuit control mechanism. Accordingly, when the depth-based enforcement condition is satisfied, the processor 104 blocks the nested dispatch request irrespective of validity of an authorization token validated by the authorization token validation module 118. In other words, presence of a valid authorization token does not override the depth-based restriction imposed by the first-layer enforcement module. This configuration establishes an enforcement invariant that nested write-capable dispatch requests are prohibited independent of authorization state.

In one embodiment, the first control layer operates as a non-overridable enforcement invariant such that authorization-token validity, policy-derived execution permissions, role-based authorization states, or alternative execution credentials are insufficient to permit nested write-capable dispatch operations once the predefined nested-dispatch threshold condition is satisfied.

At step 514, upon blocking the nested dispatch request, the processor 104 generates a control response instructing the first-level writer agent 130A to return execution control to the main orchestrator 126 or to reissue the dispatch request at a permissible dispatch depth. The response is generated using the structured response generator 124 and may include an indication of the enforcement layer responsible for blocking the request and a recommended corrective action.

At step 512, when the depth-based enforcement condition is not satisfied, the processor 104 permits the dispatch request to proceed to a second-layer enforcement module of the two-layer enforcement engine 116 for further evaluation based on execution phase conditions and authorization token validation.

Thus, the configuration illustrated in FIG. 5 ensures that nested write-capable dispatch operations are prevented at a pre-dispatch stage, thereby eliminating recursive execution chains that could otherwise result in uncontrolled file-system mutations, inconsistent system state, or resource contention.

In another embodiment, the authorization token validation module 118 is configured to validate authorization using one or more alternative authorization mechanisms in addition to or in place of a token-based scheme. Such mechanisms include capability flags associated with a target agent, role-based access credentials, policy-based authorization rules, cryptographic signatures, or execution permissions derived from a centralized or distributed policy engine. The processor 104 is configured to evaluate the authorization state using such alternative mechanisms to determine whether the request corresponds to a permitted write-capable operation, thereby enabling flexible enforcement models that are not limited to token-based authorization.

In another embodiment, the composite write-intent classifier 110 is configured to determine write intent using one or more alternative detection mechanisms including static analysis of agent instructions, semantic parsing of execution plans, behavioral profiling of agent actions, tool invocation patterns, or machine learning-based classification models trained to identify write-capable operations. The processor 104 is configured to combine outputs from such mechanisms to improve accuracy of write-intent determination and to prevent circumvention through obfuscation of task prompts.

In another embodiment, the system 100 is implemented in a distributed architecture wherein the pre-dispatch hook engine 108, the dispatch-depth resolver 112, the protected phase detector 114, and the two-layer enforcement engine 116 are executed across multiple computing nodes. The computing device 102 is configured to communicate with one or more remote nodes via a network, wherein enforcement decisions are coordinated across the nodes to maintain consistency of dispatch control. The runtime state information and marker artifacts are synchronized across the nodes to ensure accurate determination of dispatch depth and execution phase in distributed agent orchestration environments.

In another embodiment, the system 100 operates in a hybrid execution environment wherein portions of the processing are performed on an edge computing device and portions are performed on a cloud-based computing system. The pre-dispatch hook engine 108 may be executed locally on the computing device 102 to intercept requests with minimal latency, while the authorization token validation module 118 and the two-layer enforcement engine 116 are executed in a cloud environment to enforce centralized policy control. Such hybrid execution improves scalability and enables enforcement across multiple agent sessions operating in different environments.

In another embodiment, the dispatch-depth resolver 112 is configured to determine dispatch depth using alternative mechanisms including call stack inspection, parent-child execution tracing, session lineage tracking, or graph-based representation of agent interactions. The processor 104 is configured to compute the dispatch depth based on such representations to identify nested dispatch conditions even in absence of explicit depth parameters or marker artifacts.

In another embodiment, the two-layer enforcement engine 116 is configured to enforce execution control at multiple stages including pre-dispatch, mid-execution, and post-execution stages. The processor 104 may perform pre-dispatch blocking to prevent execution, mid-execution interruption to halt ongoing operations, and post-execution validation to revert unauthorized file-system mutations. Such multi-stage enforcement provides additional safety guarantees and reduces risk of unintended system modifications.

In another embodiment, the target agent is identified using an agent identity model comprising one or more of a unique agent identifier, session identifier, execution context identifier, or cryptographic identity. The processor 104 is configured to track agent identity across dispatch operations to determine relationships between agents and to accurately identify nested dispatch scenarios.

In some embodiments, the system 100 improves operation of a computing system by enforcing execution control at a pre-dispatch stage, thereby preventing unsafe recursive execution of agent processes and reducing unintended file-system mutations. The combination of dispatch-depth evaluation, execution phase detection, and authorization validation enables the processor 104 to modify execution behavior of the computing system itself, rather than merely evaluating abstract decision rules, thereby enhancing system stability, resource utilization, and data integrity.

The disclosed architecture improves operation of a computing system by implementing deterministic pre-dispatch execution governance for multi-agent artificial intelligence runtimes. The coordinated enforcement of dispatch-depth validation, fail-closed marker evaluation, bounded authorization-token validation, protected-phase execution control, and workspace-scoped authorization modifies operation of the computing environment itself to prevent unauthorized recursive file mutation and uncontrolled nested execution.

The disclosed architecture therefore provides a technical improvement in runtime orchestration integrity, execution determinism, and file-system protection within artificial intelligence agent execution environments.

In some embodiments, the two-layer enforcement engine 116 is configured to interface with a policy engine that defines enforcement rules based on system configuration, user preferences, or organizational policies. The processor 104 is configured to dynamically update enforcement conditions based on the policy engine, thereby enabling adaptive control of agent execution in response to changing system requirements.

In one embodiment, the system 100 for controlling file-writing dispatch in a multi-agent artificial intelligence environment by enforcing authorization prior to execution of write-capable agents. The system 100 provides a mechanism for intercepting agent dispatch requests at a pre-dispatch stage to evaluate execution conditions before file mutation occurs. The system 100 provides a framework for identifying write-capable or write-intent-bearing agent tasks using runtime classification techniques. The system 100 provides a mechanism for determining dispatch hierarchy and distinguishing between direct and nested agent dispatch operations.

In one embodiment, the system 100 prevents recursive or nested dispatch of write-capable agents that may lead to uncontrolled file modifications or system instability. The system 100 provides a controlled authorization mechanism using time-limited tokens for enabling permitted write operations under defined execution conditions. The system 100 ensures that file-writing operations are permitted only within authorized execution contexts associated with specific runtime states. The system 100 provides a fail-safe enforcement mechanism that blocks unauthorized or indeterminate write operations to maintain system integrity.

In one embodiment, the system 100 reduces unintended file mutations, race conditions, and inconsistent system states in multi-agent execution environments. The system 100 enables controlled delegation and parallel execution of agents while maintaining strict governance over write-capable operations.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

What is claimed is:

1. A system for controlling file-writing dispatch in a multi-agent artificial intelligence environment, comprising:
a computing device having a processor, and a memory coupled to the processor and storing executable instructions,
wherein the processor is configured to execute the instructions to:
intercept, via a pre-dispatch hook engine integrated within an agent orchestration runtime, a request to dispatch a target agent prior to execution of the target agent;
classify the request using a composite write-intent classifier to determine whether the request corresponds to a write-capable operation, wherein the composite write-intent classifier evaluates membership of the target agent in a registry of write-capable agent types and evaluates one or more natural-language signals associated with a task prompt;
determine a dispatch depth associated with the request using a dispatch-depth resolver configured to evaluate runtime state information and at least one persistent marker artifact;
assign a restricted nested-dispatch state when the at least one persistent marker artifact is malformed, invalid, corrupted, indeterminate, or non-parseable, thereby implementing fail-closed marker enforcement;
determine whether a protected execution phase is active using a protected phase detector based on persisted runtime state;
validate an authorization token using an authorization token validation module based on at least a creation timestamp, a bounded time-validity condition, and, when a workspace identifier is present within the authorization token, validation of the workspace identifier against a current execution workspace;
enforce, using a two-layer enforcement engine, a first control layer configured to unconditionally block nested write-capable dispatch operations independent of downstream authorization outcomes when the dispatch depth indicates nested dispatch;
enforce, using the two-layer enforcement engine, a second control layer configured to block the request during the protected execution phase unless a valid authorization token is present;
permit or block execution of the target agent via a target agent execution module prior to file-system mutation based on outcomes of the first control layer and the second control layer,
wherein unauthorized file-writing operations are prevented at a pre-execution stage, thereby improving integrity of the multi-agent execution environment.

2. The system of claim 1, wherein the composite write-intent classifier comprises a predefined negative list of read-only agent types, and the processor is configured to permit execution of requests corresponding to the read-only agent types independent of the write-intent determination.

3. The system of claim 1, wherein the dispatch-depth resolver is configured to determine the dispatch depth using a prioritized evaluation of a caller-supplied depth parameter, a runtime-state dispatch-depth field, and the persistent marker artifact, and wherein the dispatch-depth resolver assigns the restricted nested-dispatch state when the persistent marker artifact is present but invalid, thereby implementing fail-closed behavior.

4. The system of claim 3, wherein the prioritized evaluation performed by the dispatch-depth resolver comprises sequential fallback evaluation of the caller-supplied depth parameter, the runtime-state dispatch-depth field, a legacy dispatch-depth parameter, the persistent marker artifact, and a restricted nested-dispatch fallback state applied upon validation failure of the persistent marker artifact.

5. The system of claim 1, wherein the authorization token optionally comprises a workspace identifier derived from a working directory, and the authorization token validation module validates the workspace identifier against a current execution workspace when the workspace identifier is present within the authorization token, wherein the workspace identifier is generated by applying a SHA-256 hashing operation to a workspace path, working directory identifier, repository identifier, or execution-context location, and truncating a resulting hash value to a sixteen-hex-character prefix for storage and runtime authorization validation.

6. The system of claim 1, wherein the authorization token validation module validates the authorization token based on a time validity condition defined as a minimum of a declared time-to-live associated with the token, and a predefined maximum time window enforced by the system.

7. The system of claim 1, wherein the authorization token validation module clamps a declared token lifetime to a maximum ceiling of sixty seconds irrespective of a larger declared token lifetime value.

8. The system of claim 1, wherein the two-layer enforcement engine is configured such that the first control layer is applied before the second control layer such that nested write-capable dispatch requests are blocked irrespective of validity of the authorization token.

9. The system of claim 1, wherein the protected execution phase comprises at least one of a test-authoring phase, a code-implementation phase, or a remediation phase, and wherein write-capable operations are restricted during the protected execution phase in absence of a valid authorization token.

10. The system of claim 1, wherein the processor is further configured to implement a team-mode check module configured to bypass the first control layer and the second control layer when the runtime state indicates execution of agents in isolated execution sessions lacking shared persistent-storage mutation capability, shared repository modification capability, shared deployment propagation capability, shared runtime execution lineage, or coordinated persistent-state modification capability associated with a common execution environment, and wherein enforcement of the first control layer and the second control layer is maintained when logically separate execution sessions remain capable of shared mutation propagation within the common execution environment.

11. The system of claim 1, wherein the processor is further configured to implement a structured response generator configured to generate a structured rejection response upon blocking the request, wherein the structured rejection response indicates at least one of a control layer responsible for blocking, and a corrective action for enabling authorized execution.

12. A method for controlling file-writing dispatch in a multi-agent artificial intelligence environment using a system, comprising:
receiving a request to dispatch a target agent;
intercepting, via a pre-dispatch hook engine, the request prior to execution of the target agent;
classifying, using a composite write-intent classifier, the request to determine whether the request corresponds to a write-capable operation;
determining, using a dispatch-depth resolver, a dispatch depth associated with the request based on runtime state information and at least one persistent marker artifact;
assigning a restricted nested-dispatch state when the persistent marker artifact is malformed, corrupted, indeterminate, or non-parseable;
determining, using a protected phase detector, whether a protected execution phase is active;
validating, using an authorization token validation module, an authorization token based on at least a creation timestamp, a bounded time-validity condition, and, when a workspace identifier is present within the authorization token, validation of the workspace identifier against a current execution workspace;
applying, using a two-layer enforcement engine, a first control layer configured to unconditionally block nested write-capable dispatch operations when the dispatch depth indicates nested dispatch;
applying, using the two-layer enforcement engine, a second control layer configured to block execution during the protected execution phase unless the authorization token is valid;
permitting execution of the target agent only when neither the first control layer nor the second control layer blocks execution; and
blocking file-writing dispatch operations prior to file-system mutation when validation failure conditions are detected.

13. The method of claim 12, wherein the method further comprises permitting execution of requests corresponding to read-only agent types independent of the write-intent determination using a predefined negative list of read-only agent types.

14. The method of claim 12, wherein the method further comprises determining the dispatch depth using prioritized evaluation of a caller-supplied depth parameter, a runtime-state dispatch-depth field, and the persistent marker artifact, and assigning the restricted nested-dispatch state when the persistent marker artifact is invalid to implement fail-closed behavior.

15. The method of claim 12, wherein the method further comprises, when a workspace identifier derived from a working directory is present within the authorization token, validating the workspace identifier against a current execution workspace.

16. The method of claim 12, wherein the method further comprises validating the authorization token using a time-validity condition defined as a minimum of a declared time-to-live associated with the token and a predefined maximum time window enforced by the system.

17. The method of claim 12, wherein applying the first control layer prior to the second control layer causes nested write-capable dispatch requests to be blocked irrespective of validity of the authorization token.

18. The method of claim 12, wherein the protected execution phase comprises at least one of a test-authoring phase, a code-implementation phase, or a remediation phase, and wherein write-capable operations are restricted during the protected execution phase in absence of a valid authorization token.

19. The method of claim 12, wherein bypassing the first control layer and the second control layer occurs only when the runtime state indicates execution of agents in isolated execution sessions lacking shared persistent-storage mutation capability, shared repository modification capability, shared deployment propagation capability, shared runtime execution lineage, or coordinated persistent-state modification capability associated with a common execution environment.

20. A non-transitory computer-readable medium storing instructions that, when executed by one or more processors, cause the one or more processors to:
intercept a request to dispatch a target agent prior to execution of the target agent;
classify the request to determine whether the request corresponds to a write-capable operation;
determine a dispatch depth associated with the request based on runtime state information and at least one persistent marker artifact;
assign a restricted nested-dispatch state when the persistent marker artifact is malformed, corrupted, indeterminate, or non-parseable;
determine whether a protected execution phase is active;
validate an authorization token based on at least a creation timestamp, a bounded time-validity condition, and, when a workspace identifier is present within the authorization token, validation of the workspace identifier against a current execution workspace;
apply a first control layer configured to unconditionally block nested write-capable dispatch operations when the dispatch depth indicates nested dispatch;
apply a second control layer configured to block execution during the protected execution phase unless the authorization token is valid; and
permit or block execution of the target agent prior to file-system mutation based on outcomes of the first control layer and the second control layer.
